(19) United States
(12) Patent Application Publication
(10) Pub. No.: US 2025/0178074 A1
(43) Pub. Date: Jun. 5, 2025

(54) PROCESS FOR EVAPORATIVE CASTING

(71) Applicant: Skuld LLC, London, OH (US)

(72) Inventors: Mark DeBruin, London, OH (US); Sarah Elizabeth Jordan, London, OH (US)

(73) Assignee: Skuld LLC, London, OH (US)

(21) Appl. No.: 19/043,217

(22) Filed: Jan. 31, 2025

Related U.S. Application Data
(63) Continuation of application No. 18/475,495, filed on Sep. 27, 2023, now abandoned.
Application No. 18/475,495 is a continuation-in-part of application No. PCT/US22/22071, filed on Mar. 26, 2022.
(60) Provisional application No. 63/377,880, filed on Sep. 30, 2022.
(60) Provisional application No. 63/167,238, filed on Mar. 29, 2021.

(51) Int. Cl. B22C 7/02; B22C 9/04; B33Y 10/00; B33Y 80/00

(52) U.S. Cl. CPC B22C 7/02; B22C 9/046; B33Y 10/00; B33Y 80/00

(57) ABSTRACT

A method for evaporative casting includes the steps of: using three-dimensional (3D) printing to print only a hollow shell in 3D of a full-sized target part according to an algorithm, forming a hardened coating of ceramic mold over an entire exterior surface of the 3D printed hollow shell, forming a pre-cast assembly by connecting the hardened ceramic mold to an end of a conduit, burying completely the pre-cast assembly under compacted sand or ceramic beads while an inlet to the conduit is kept free and open at an upright position to receive a selected cast material in a molten state, the selected cast material in molten state evaporating the 3D hollow shell to completely fill up an entire volume enclosed by an inner surface of the hardened ceramic mold, and cooling to solidify the selected cast material inside the pre-cast assembly to yield the at least one full-sized target part.

### CROSS-REFERENCE TO RELATED APPLICATIONS

This application is a continuation in part of International Application No. PCT/US22/22071, filed on Mar. 26, 2022, which claims the benefit of U.S. Provisional Application No. 63/167,238, filed on Mar. 29, 2021. This application also claims the benefit of U.S. Provisional Patent Application No. 63/377,880, filed on Sep. 30, 2022. Each of these applications is incorporated by reference herein in its entirety.

### BACKGROUND

It is more efficient to pour molten metal (i.e., casting) to form an integral finished part than welding or assembling multiple components together. The history of foundries dates back to the Bronze Age (3500 BC) and Iron Age (1200 BC), which are named after the predominant foundry technology of the era. At that time and until modern industrial times, there were only two types of casting: (1) greensand casting and (2) investment casting.

In greensand casting, the molds are made of a mixture of water, sand, and clay. The molds are made to form a hollow space into which molten metal is poured. The metal cools into a solid piece as a casting in the shape of the cavity in the sand. The mold is dumped out to get the casting, and the sand can be re-used. Tolerances in greensand casting are approximately +/−1.01 mm per mm (0.040 in. per in.), so in most cases, significant machining may be required to yield a finished part.

Investment casting, also called lost wax casting, is a much more precise process than greensand casting and maintains tolerances of +/−0.076 mm per mm (0.003 in. per in.). Investment casting is still used for sculptures and jewelry. It is also used for casting precision parts, such as aircraft engine turbine blades. Investment casting starts by having a piece of wax in the desired shape. The wax can be made by machining, made in a mold, or even hand carved. Pieces are attached to an assembly that feeds the desired shape during pouring. The wax is dipped into a ceramic coating (called the investment) and is allowed to dry. The coating and drying steps are repeated seven to 12 times. Typically, there are 24 hours between each coating step. The coating is typically built up to 6.35 mm to 12.7 mm (0.25 to 0.50 in.) thick. The mold is heated to melt the wax, which is dumped out of the mold. This leaves behind a hollow cavity. Molten metal is poured into the mold. The metal is allowed to cool and solidify. Removing the investment casting mold is difficult. Typical methods include mechanical means such as hammers, shot/grit blasting, and waterjets. After the investment is removed, the part (casting) is cut off of the gating system. The process takes two weeks or more.

### SUMMARY

In one aspect, a method for evaporative casting is provided, the method comprising: using three-dimensional (3D) printing to print only a hollow shell in 3D of at least one full-sized target part according to an algorithm; applying a layer of ceramic coating over an entire exterior surface of the 3D printed hollow shell forming a hardened ceramic mold, wherein the hardened ceramic mold being fully enclosed and having an opening at a lower end; forming a pre-cast assembly by connecting the opening at the lower end of the hardened ceramic mold to an end of a conduit, while an opposite end of the conduit is configured as an inlet to the pre-cast assembly; burying completely the pre-cast assembly under compacted sand or ceramic beads wherein the inlet of the conduit is kept free and open at an upright position to receive a selected cast material in a molten state; pouring the molten selected cast material into the inlet of the pre-cast assembly, wherein the molten selected cast material travels down the conduit by gravity to entirely fill the pre-cast assembly by evaporating all of the 3D printed hollow shell, such that the molten selected cast material completely fills up an entire volume enclosed by an inner surface of the hardened ceramic mold; and cooling to solidify the selected cast material inside the pre-cast assembly to yield a cast of at least one full-sized target part.

### BRIEF DESCRIPTION OF THE FIGURES

The accompanying figures, which are incorporated in and constitute a part of the specification, illustrate various example systems and methods and are used merely to illustrate various example aspects. In the figures, like elements bear like reference numerals.

FIG. 1 illustrates an example of using 3D printing to print only a hollow shell 100 in 3D of a full-sized target part according to an algorithm.

FIG. 2 illustrates an example of a pre-cast assembly 240 formed from a hardened coating of ceramic mold 204 over an entire exterior surface of the 3D printed hollow shell.

FIG. 3 illustrates an example of pouring the selected cast material into a pre-cast assembly while the cast material is in a molten state.

FIG. 4 illustrates a cutaway view of a pre-cast assembly 440 buried in compacted sand or ceramic beads 414; molten cast material 416 is poured into an inlet to evaporate the material of the 3D hollow shell 100.

FIG. 5 illustrates cooling to solidify a cast from the molten selected cast material.

FIG. 6 illustrates an example of a target cast part 620 from the evaporative casting process.

FIG. 7 illustrates an upright position of a pre-cast assembly 740 that is connected to an inlet of a conduit 710 into which molten selected cast material 716 is being poured.

FIG. 8 illustrates an upright position of a bottom gate pre-cast assembly 840 that is connected to an inlet of a conduit into which molten selected cast material is being poured.

FIG. 9 illustrates an upright position of a top gate pre-cast assembly 940 that is connected to an inlet of a conduit into which molten selected cast material is being poured.

FIG. 10A illustrates a cutaway view of a pre-cast assembly 1040 buried in compacted sand or ceramic beads 1014; molten cast material 1016 is poured into an inlet to evaporate the material of a 3D hollow shell 1000.

FIG. 10B illustrates a partial magnified view of pre-cast assembly 1040.

FIG. 11A illustrates a bottom gate pre-cast assembly 1140 that is connected to an inlet of a conduit into which molten selected cast material may be poured.

FIG. 11B illustrates a partial magnified view of bottom gate pre-cast assembly 1140.

FIG. 12A illustrates a bottom gate pre-cast assembly 1240 that is connected via glue 1238 to an inlet of a conduit into which molten selected cast material may be poured.

FIG. 12B illustrates a partial magnified view of bottom gate pre-cast assembly 1240.

FIG. 13A illustrates a bottom gate pre-cast assembly 1340 that is connected to an inlet of a conduit into which molten selected cast material may be poured.

FIG. 13B illustrates a partial magnified view of bottom gate pre-cast assembly 1340.

FIG. 14 illustrates a comparison of a lost foam pre-cast assembly versus an additive manufacturing evaporative casting assembly.

FIG. 15 illustrates a bottom gate pre-cast cluster assembly 1540 that is connected to an inlet of a conduit into which molten selected cast material may be poured.

FIG. 16A illustrates a top gate pre-cast assembly 1640 that is connected to an inlet of a conduit into which molten selected cast material may be poured.

FIG. 16B illustrates a partial magnified view of top gate pre-cast assembly 1640.

FIG. 17 illustrates an example method 1760 for obtaining a cast part.

### DETAILED DESCRIPTION

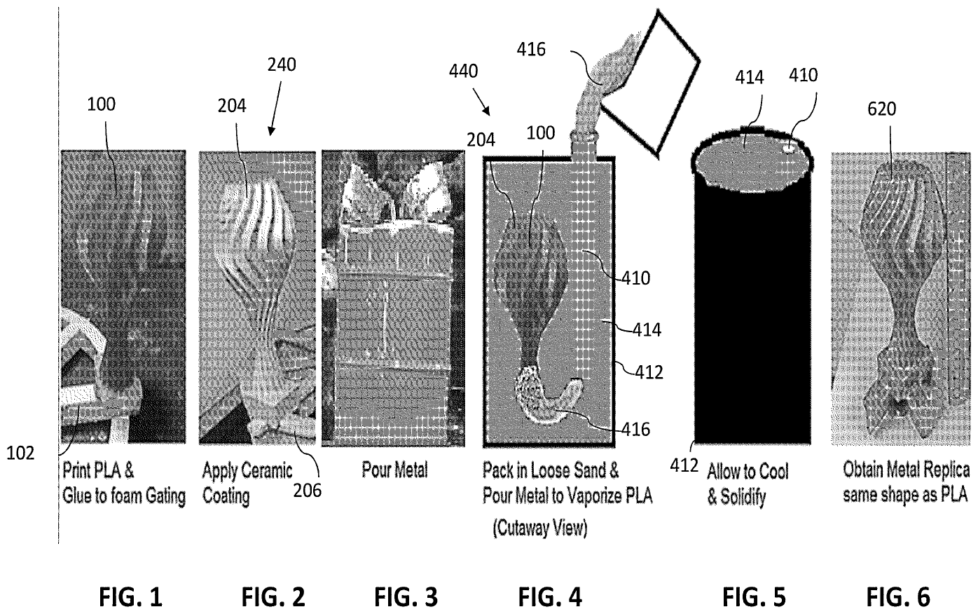

FIG. 1 illustrates an example of using 3D printing to print only a hollow shell 100 in 3D of a full-sized target part according to an algorithm. Hollow shell 100 may be fixed to a foam gating member 102. Hollow shell 100 may be fixed to foam gating member 102 via any of a variety of mechanisms, including for example a glue.

Hollow shell 100 may be used in an evaporative casting process, which involves the use of 3D printing to print only a hollow shell (e.g., hollow shell 100) of a full-sized target part according to an algorithm. Hollow shell 100 may be formed from any of a variety of materials, including for example a polymer material such as polylactic acid (PLA) filaments.

The evaporative casting method may incorporate the benefits and capabilities of a 3D printer to print a casting mold prototype (target part) by printing only a hollow shell (e.g., hollow shell 100) in 3D or only an envelope, instead of a solid version of a full-sized target part. Thus, both the amount of PLA materials used and the printing time of the 3D printing are substantially reduced. In addition, a reduction in the amount of PLA materials used to create the 3D hollow shell of the full-sized target part also substantially reduces the amount of PLA materials being burned off or evaporated, thus further reducing the risks of trapping gas bubbles within the solidified cast part. As described further below, gases trapped during evaporation of hollow shell 100 when pouring a molten material may result in forming voids, which are defects on the target part.

In an example, a 3D printed hollow shell 100 of full-sized target parts may achieve a part tolerance of up to +/−0.051 mm (0.002 in.) and may achieve a surface finish of up to 0.0016 mm with 0.0051 mm-0.0076 mm typical (64 microinch with 200-300 typical) root mean square (RMS). The 3D hollow shell may have a first range of wall thicknesses, which is either experimentally determined or mathematically modeled over one or a combination of parameters: for example, surface area pattern and size detail of the cast target part, polymer materials dispensing needle diameter, and physical properties of polymer materials.

In one aspect, hollow shell 100 may include a range of wall thicknesses of about 0.15 mm (0.006 in.) to about 1.00 mm (0.040 in.). Thicknesses below 0.15 mm may cause hollow shell 100 to lack structural integrity to prevent collapse under its own weight or the weight of a ceramic coating. Thicknesses above 1.00 mm may result in too much gas being generated during evaporation of hollow shell 100, resulting in defects and possibly explosions. Thicknesses of hollow shell 100, or of specific portions of hollow shell 100, may be selected based upon the minimum material thickness capable of providing hollow shell 100 with the structural integrity necessary to support its own weight and/or be coated with a ceramic. Once hollow shell 100 is printed, the volume of gas expected to be generated during the evaporation of hollow shell 100 may be calculated, and a plan may be developed regarding how to disperse that volume of gas.

FIG. 2 illustrates an example of a pre-cast assembly 240 formed from a hardened coating of ceramic mold 204 over an entire exterior surface of 3D printed hollow shell (not shown, but illustrated in FIG. 1 as hollow shell 100). Pre-cast assembly 240 includes a hardened coating of ceramic mold 206 over a foam gating member (not shown, but illustrated in FIG. 1 as foam gating member 102).

In practice, a layer of ceramic coating may be applied over an entire exterior surface of the hollow shell 100, forming a hardened ceramic mold 204, wherein hardened ceramic mold 204 is fully enclosed and includes an opening at a lower end. As discussed further below, pre-cast assembly 240 may be formed by connecting the opening at the lower end of the hardened ceramic mold to an end of a conduit, while an opposite end of the conduit may be configured as an inlet to the pre-cast assembly.

In one aspect, ceramic mold 204 may include a range of wall thicknesses of about 0.025 mm (0.001 in.) to about 0.381 mm (0.015 in.). Thicknesses below 0.025 mm may cause ceramic mold 204 to crack during casting, resulting in a “burnt-on sand defect” in which a molten cast material escapes from ceramic mold 204 and contacts the surrounding sand, coating the sand in the molten cast material, which is very difficult to remove from the target cast part. Thicknesses above 0.381 mm may prevent the volume of gas generated during evaporation of hollow shell 100 from escaping through ceramic mold 204 fast enough, or at all. A build-up of the gas may lead to defects in the target cast part and/or explosions.

FIG. 3 illustrates an example of pouring the selected cast material into a pre-cast assembly while the cast material is in a molten state. FIG. 4 illustrates a cutaway view of a pre-cast assembly 440 buried in compacted sand or ceramic beads 414; molten cast material 416 is poured into an inlet of a conduit 410 to evaporate the material of the 3D hollow shell 100 and fill pre-cast assembly 440. Pre-cast assembly 440 may be contained within a container 412.

Pre-cast assembly 440 is disposed in an upright, bottom gate position, where the inlet of conduit 410 is bent in such a way to keep at an upright position. Selected cast material 416 in a molten state may flow by gravity down conduit 410 to evaporate the material of hollow shell 100 in a bottom portion, then continue to flow upward (due to a difference in height level of molten cast material 416) to evaporate the material of hollow shell 100 in the enclosed top portion until the entire volume inside the inner surface of pre-cast assembly 440 is filled with cast material 416, without a void.

In another example, pre-cast assembly 440 may be disposed in an inverted, top gate position in which the top portion of pre-cast assembly 440 is facing downward and the bottom portion of pre-cast assembly 440 is facing upward, while conduit 410's inlet remains at an upright position to receive selected cast material 416 in a molten state. When disposed in the inverted position, selected cast material 416 in a molten state may flow downward by gravity to start evaporating the material of hollow shell 100 in the bottom portion of pre-cast assembly 440. Cast material 416 may then continue to flow downward to evaporate the material of hollow shell 100 in the enclosed top portion (which is inverted to point downward) until the entire volume inside the inner surface of pre-cast assembly 440 is completely filled with cast material 416, without a void.

The decision to bury pre-cast assembly 440 in an inverted position or in an upright position in compacted sand or ceramic beads 414 for pouring of molten cast material 416 may be dependent upon the density of molten cast material 416. Yet alternately, pre-cast assembly 440 may be disposed at an angle (not shown) inside compacted sand or ceramic beads 414.

FIG. 5 illustrates cooling to solidify a cast from the molten selected cast material. FIG. 6 illustrates an example of a target cast part 620 from the evaporative casting process. Cooling cast material 416 causes cast material 416 to solidify to yield the full-sized target part 620 in a cast from molten selected cast material 416. Left over sand or ceramic beads 414, and any ceramic coating 204, may be removed to yield target cast part 620 from the evaporative casting.

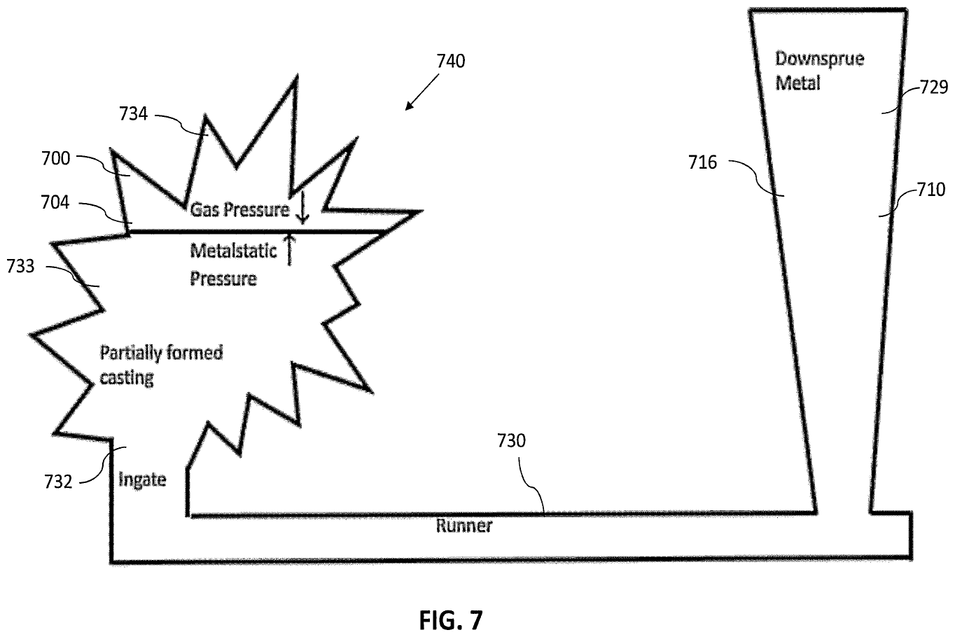

FIG. 7 illustrates an upright position of a pre-cast assembly 740 that is connected to an inlet of a conduit 710 into which molten selected cast material 716 is being poured. Conduit 710 may include a downsprue 729, a runner 730, and an ingate 732. Conduit 710, to include downsprue 729, runner 730, and ingate 732, provide a path (e.g., a tube, after coating with a ceramic mold) through which cast material 716 is ducted into an interior of a ceramic mold 704. Ingate 732 is connected to ceramic mold 704 in a bottom gate configuration. Cast material 716 enters conduit 710, and melts the foam substrate about which ceramic material is formed, allowing cast material 716 to flow through conduit 710 and into ceramic mold 704.

While cast material 716 enters ceramic mold 704 and evaporates hollow shell 700, the interior of ceramic mold 704 includes a cast portion 733 (making a partially formed casting) and an uncast portion 734. The objective is to fill the entirety of the interior of ceramic mold 704 with cast material 716, resulting in the elimination of uncast portion 734. As hollow shell 700 evaporates, gases are generated. The gases escape to uncast portion 734, where gas pressure builds. The gas pressure within uncast portion 734 encounters and acts against metal static pressure of cast material 716 within cast portion 733. Gas within uncast portion 734 is able to escape through ceramic mold 704 as described further below.

As previously discussed, pre-cast assembly 740 may be buried in various positions including upright, inverted, and tilted at an angle. The selected position may be based on selected cast material 716 for casting, being at least one of: aluminum alloys, brass alloys, copper alloys, cobalt alloys, bronze alloys, iron alloys, nickel, nickel alloys, steel alloys, stainless steel, and stainless steel alloys.

In one aspect, cast material 716 is a nickel-based alloy. In one aspect, a nickel-based alloy is a high alloy with nickel as the matrix and, e.g., chromium, tungsten, copper, molybdenum, cobalt, aluminum, titanium, boron, zirconium, and other elements as alloying elements. Nickel-based alloys may have an austenitic structure and have high strength and good oxidation resistance, corrosion resistance, and temperature resistance. Suitable nickel alloys may include, for example: 20Mo4, 20Mo6, B-1900, B-1900Hf, C1023, C-101, CMSX-2/3, CMSX-4, CMSX-6, D979, D-205, Hast B, Hast B-2, Hast B-3, Hast C2000, Hast C-22, Hast C-276, Hast C-4, Hast D, Hast F, Hast G, Hast G-2, Hast G-3, Hast G-30, Hast N, Hast R, Hast S, Hast W, Hast X, Haynes 214, Haynes 230, Haynes 242, Haynes 59, HR-160, HW6015, Hy Mu 80, IN-100, Inco 102, Inco 600, Inco 601, Inco 617, Inco 625, Inco 686, Inco 690, Inco 700, Inco 702, Inco 706, Inco 713, Inco 713M, Inco 718, Inco 722, Inco 725, Inco 738, Inco 754, Inco 792, Inco 800, Inco 800H, Inco 800HT, Inco 825, Inco 901, Inco 939, Inco X-750, M252, Mar M 002, Mar M 200, Mar M 246, Mar M 247, Monel 400, Monel 401, Monel 411, Monel K500, Monel R405, MP-35-N, Mu Metal, N4M2, NA 22H, NA Sup22H, Ni-200, Nichrome V, Nimonic 105, Nimonic 115, Nimonic 75, Nimonic 80, Nimonic 90, Nimonic 263, PWA 1480, PWA 1484, RA 333, Refract 26, Rene 125, Rene 142, Rene 220, Rene 41, Rene 77, Rene 80, Rene 85, Rene 95, SuperTherm, Thetalloy, Udimet 500, Udimet 520, Udimet 700, Waspaloy, and combinations thereof.

If a lower density of the selected cast material 716 is being used for casting, an inverted or a tilted angle burying position may be used. If a higher density of the selected cast material 716 is being used for casting, an upright or the tilted angle burying position may be used. However, higher density cast materials 716 may be used in inverted positions, and lower density cast materials 716 may be used in upright positions.

It may be more desirable to utilize a bottom gate arrangement (e.g., those assemblies illustrated in FIGS. 4, 7, and 9-14) as a bottom gate arrangement reduces turbulence and leads to more laminar flow of cast material 716 and less potential for defects in the final target part.

A top gate arrangement may be preferable when casting aluminum, magnesium, and/or beryllium cast materials 716 because those materials' densities are so low that the metal static pressure formed when casting those materials is at times not high enough to push the gas out of uncast portion 734.

During casting, the head pressure (metal static pressure) of cast material 716 within cast portion 733 of ceramic mold 704 must be greater the gas pressure within uncast portion 734, and additionally must be great enough to push the gas within uncast portion 734 out of the walls of ceramic mold 704.

The head pressure of cast material 716 within cast portion 733 is a function: ƒ(P)∝g*H*V*ρ, where P is the pressure, g is the gravity constant, H is the height of the column of cast material 716 above the ceramic mold 704's mold wall, V is the volume of the cast material 716 above the part, and ρ is the density of cast material 716 and used to calculate the mass being pulled down by gravity.

The gas pressure of the gas within uncast portion 734, on the other hand, is dependent upon the mass of the polymer (of hollow shell 700) being vaporized, and the ideal gas law, and also varies with temperature. The ideal gas law is written in an empirical form as PV=nRT. To determine the gas pressure, one calculates the mass of polymer to vaporize (i.e., the mass of polymer used to form hollow shell 700) and converts that mass to the number of moles of polymer. One next determines how much the polymer compounds will expand in transitioning from a solid to a gas and how much the polymer compounds will expand due to the temperature increase from room temperature to the molten metal temperature. These expansion calculations allow one to determine the expected gas pressure of gas within uncast portion 734.

In one example embodiment, cast material 716 is a nickel-based alloy. Cast material 716 may be Nickel 713M/Alloy 713M/Inco 713M. Pre-cast assembly 740 is connected to an inlet of conduit 710 in a bottom gate arrangement. Pre-cast assembly 740 uses a 3D printed hollow shell prepared using a 0.4 mm nozzle for printing. Perforations (e.g., holes) may be manually formed through the 3D printed hollow shell (following completion of the printing) at least every 0.4 in. (1.0 cm) where the 3D printed hollow shell is not sufficiently permeable for a gas to pass through during casting. A determination as to whether the 3D printed hollow shell is sufficiently permeable may occur after printing and attempting casting. The 3D printed hollow shell may not be sufficiently permeable where the print includes multiple layers printed repeatedly in the Z-axis direction; tipping the print so that the layers are slightly offset during printing may remedy this issue. An ingate foam of at least 0.5 in. (1.27 cm). The 3D printed hollow shell is coated with a coating having a specific heat capacity of 250 cp to 450 cp (J/kgK). Cast material 716 is poured with at least 2,650 degrees F. (melting point is 2,350 degrees F.) with at least 18 in. (45.7 cm) of head pressure.

In another example embodiment, cast material 716 may be Nickel 625, which has a melting point of 2,460 degrees F., and a minimum pour temperature of 2,710 degrees F. In another example, cast material 716 may be Nickel 718, which has a melting point of 2,550 degrees F., and a minimum pour temperature of 2,900 degrees F. In each of these additional nickel cast material embodiments, the remaining parameters are the same as those described above with respect to Nickel 713M/Alloy 713M/Inco 713M.

Table 1 below includes various nickel alloy and coating combinations that may be used in a similar arrangement.

TABLE 1

| | Coating | | Tap | Pour |
|---|---|---|---|---|
| | CP | | Temperature | Temperature |
| Alloy | (J/kgK) | Coating | (F.) | (F.) |
| 713 | 1950 | Foam Kote 7600 | 3074 | 2845 |
| 713 | 1950 | Foam Kote 7600 | 3074 | 2845 |
| 713 | 645 | Foam Kote 6072 | 2814 | 2765 |
| 713 | 645 | Foam Kote 6072 | 2814 | 2765 |
| 713 | 480 | Foam Kote 6072 | 2867 | 2679 |
| 713 | | Foam Kote 6072 | 3070 | 2900 |
| 713 | | Foam Kote 6072 | 3056 | 2766 |
| 713 | 280 | Foam Kote 6072 | 3075 | 3010 |
| 713 | 280 | Foam Kote 6072 | 2985 | 3010 |
| 625 | 305 | Foam Kote 6072 | 3207 | 2960 |
| 625 | 378 | Foam Kote 6072 | 3185 | 2957 |
| 713 | 378 | Foam Kote 6072 | 3214, 3218 | 2890 |

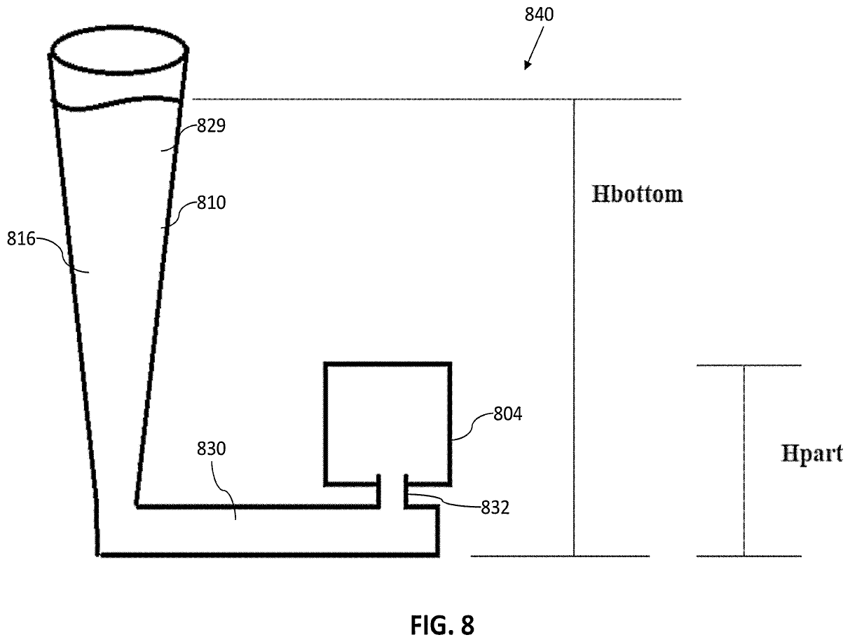

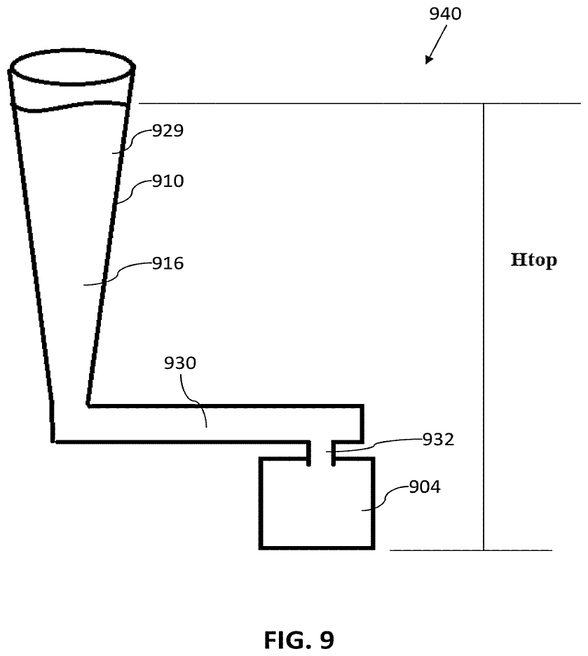

FIG. 8 illustrates an upright position of a bottom gate pre-cast assembly 840 that is connected to an inlet of a conduit 810 into which molten selected cast material 816 is being poured. Conduit 810, to include a downsprue 829, a runner 830, and an ingate 832, provide a path (e.g., a tube, after coating with a ceramic mold) through which cast material 816 is ducted into an interior of a ceramic mold 804. Cast material 816 enters conduit 810, and melts the foam substrate about which ceramic material is formed, allowing cast material 816 to flow through conduit 810 and into ceramic mold 804. FIG. 9 illustrates an upright position of a top gate pre-cast assembly 940 that is connected to an inlet of a conduit 910 into which molten selected cast material 916 is being poured. Conduit 910, to include a downsprue 929, a runner 930, and an ingate 932, provide a path (e.g., a tube, after coating with a ceramic mold) through which cast material 916 is ducted into an interior of a ceramic mold 904. Cast material 916 enters conduit 910, and melts the foam substrate about which ceramic material is formed, allowing cast material 916 to flow through conduit 910 and into ceramic mold 904. In a top gate pre-cast assembly, such as assembly 940, more metal static (head) pressure is generated due to the greater distance that gravity as acting over the height Htop. In a bottom gate pre-cast assembly, such as assembly 840, less assistance is obtained from gravity as the height Hbottom is less than height Htop. Additionally, in a bottom gate pre-cast assembly, such as assembly 840, a negative pressure is generated, working against the positive metal static (head) pressure, due to the gravity acting over the height Hpart of the part.

In one example embodiment, cast material 916 is an aluminum alloy. Pre-cast assembly 940 is connected to an inlet of conduit 910 in a top gate arrangement. Pre-cast assembly 940 uses a 3D printed hollow shell prepared using a 0.4 mm or 0.2 mm nozzle for printing. Perforations (e.g., holes) may be manually formed through the 3D printed hollow shell (following completion of the printing) at least every 0.4 in. (1.0 cm) where the 3D printed hollow shell is not sufficiently permeable for a gas to pass through during casting. A determination as to whether the 3D printed hollow shell is sufficiently permeable may occur after printing and attempting casting. The 3D printed hollow shell may not be sufficiently permeable where the print includes multiple layers printed repeatedly in the Z-axis direction; tipping the print so that the layers are slightly offset during printing may remedy this issue. An ingate foam of at least 0.15 in. (0.38 cm). The 3D printed hollow shell is coated with a coating having a specific heat capacity of 250 cp to 850 cp (J/kgK). Cast material 916 may be AlMag 535 aluminum that is poured with at least 1,350 degrees F. (melting point is 1,020 degrees F.) with at least 8 in. (20.3 cm) of head pressure.

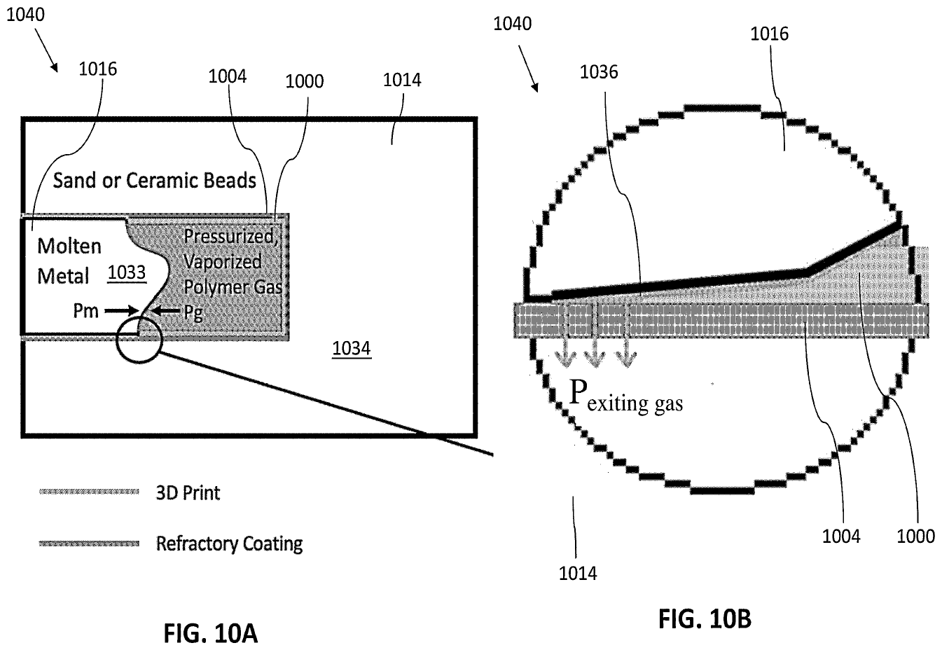

FIG. 10A illustrates a cutaway view of a pre-cast assembly 1040 buried in compacted sand or ceramic beads 1014; molten cast material 1016 is poured into an inlet to evaporate the material of a 3D hollow shell 1000. FIG. 10B illustrates a partial magnified view of pre-cast assembly 1040. Pre-cast assembly 1040 includes a polymer hollow shell 1000, coated in a ceramic to form a ceramic mold 1004. Hollow shell 1000 and ceramic mold 1004, bonded as one part, are buried in compacted sand or ceramic beads 1014, and cast material 1016 is introduced to the interior of hollow shell 1000 and ceramic mold 1004. Cast material 1016 has a temperature that is high enough to vaporize hollow shell 1000, causing a temporary shell-free area 1036 to form at the junction of a cast portion 1033 with an uncast portion 1034. Gas generated by vaporized hollow shell 1000, as well as any gas previously contained within hollow shell 1000 and ceramic mold 1004 (e.g., ambient air), can escape through ceramic mold 1004 in shell-free area 1036. Cast portion 1033, uncast portion 1034, and shell-free area 1036 are constantly changing as cast material 1016 is being added to the interior of ceramic mold 1004.

With specific reference to FIG. 10A, a metal static pressure Pm acts against a gas pressure Pg. Gas pressure Pg is pressurized, vaporized polymer gas. Metal static pressure Pm is hydrostatic pressure for the molten cast material 1016. Consideration is given to the design of pre-cast assembly 1040's gating (i.e., top gate versus bottom gate) in light of pressure Pm and Pg.

If pressure Pm is less than pressure Pg, an explosion of molten metal 1033 is likely to occur. Molten Metal 1033 may be forcefully ejected back out of the conduit (including the downsprue) into which it was poured.

If pressure Pm is equal to pressure Pg, a defect is likely to occur as component only partially fills (that is, cast portion 1033 unable to overtake the entirety of uncast portion 1034). The defect can occur at any point prior to solidification of the part after casting, or at any localized area in the part geometry.

Thus, pressure Pm must be greater than pressure Pg for a complete casting. Pressure Pm is calculated from the weight of the metal divided by the cross-sectional area. Pressure Pg is calculated using the following formula: Pg=P vaporized print+P vaporized foam−P exiting gas.

The pressure P vaporized print is the pressure of the vaporized gas generated by the vaporization of 3D printed hollow shell 1000. The pressure P vaporized foam is the pressure of vaporized foam within ceramic mold 1004, if any (applicable where lost foam casting is used as described herein). Pressure P vaporized print and pressure P vaporized foam are calculated using the Ideal Gas Law.

The pressure P exiting gas is the pressure of the vaporized polymer gas exiting assembly 1040 through ceramic mold 1004. Pressure P exiting gas is a function of the surface area of the exposed ceramic mold 1004, ceramic mold 1004's permeability, and vacuum pressure if a vacuum is used.

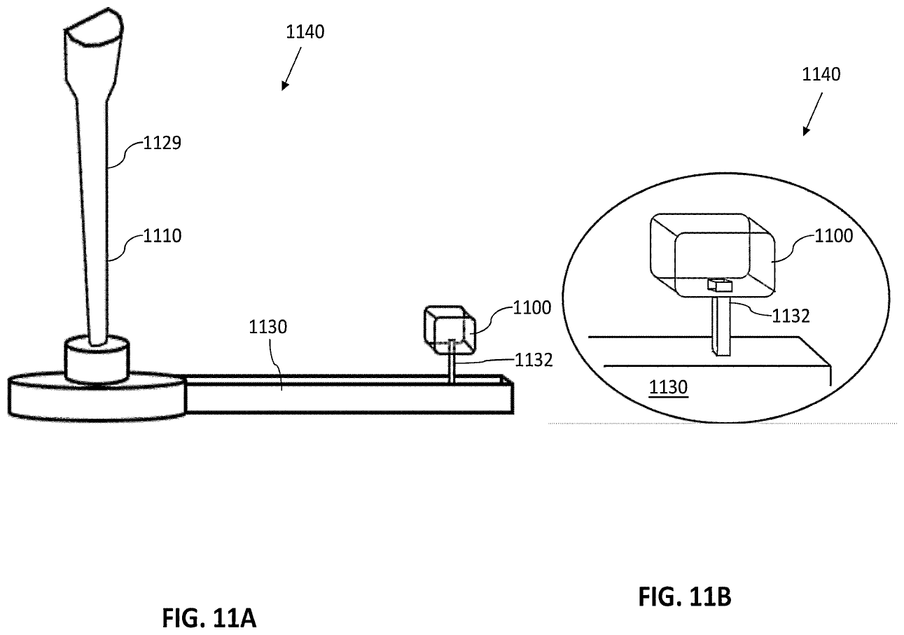

FIG. 11A illustrates a bottom gate pre-cast assembly 1140 that is connected to an inlet of a conduit 1110 into which molten selected cast material may be poured. FIG. 11B illustrates a partial magnified view of bottom gate pre-cast assembly 1140. Conduit 1110, to include a downsprue 1129, a runner 1130, and an ingate 1132, provide a path (e.g., a tube, after coating with a ceramic mold) through which cast material is ducted into an interior of a ceramic mold formed around a hollow shell 1100. Assembly 1140 is formed by connecting an opening at the lower end of a hardened ceramic mold (formed around hollow shell 1100) to an end of conduit 1110 while an opposite end of conduit 1110 is configured as a cast material inlet to assembly 1140.

In another embodiment, an additive manufacturing technique may be used in the casting method. The additive manufacturing technique combines: (1) the benefits of the 3D hollow shell printing for low cost and fast turnaround time for printing very detailed and difficult to machine structures, and (2) the benefits of lost foam casting technique. Lost foam casting may be used to consolidate many casting parts into one optimized integral structure with a tight tolerance of as high as 0.002″, which may require no further machining after casting.

Lost foam casting foams may be produced by foam blowing or by machining. Because foams can be glued or compression fit together, highly complex shapes can be assembled together. For example, these highly complex shapes may include negative draft, channels, blind holes, interconnected castings, and a host of other ordinarily impossible shapes. In addition, it is possible to machine the foam for small volumes, which may be added or merged with a 3D printed hollow shell to create a merged casting mold for evaporative casting, where molten irons alloys, steels alloys, stainless steel, stainless steels alloys, aluminum alloys, brass alloys, bronze alloys, copper alloys, nickel, nickel alloys, and more casting materials may be poured into the merged casting mold.

Evaporative casting on a merged casting mold may: (1) eliminate mold erosion for 3D sand prints, (2) eliminate size limitations of 3D prints, and (3) allow for use of a larger envelope (i.e., large size) without resorting to a more expensive 3D printer, which may also use more 3D printing materials and be more time consuming to print a larger 3D envelope or hollow shell. In addition, the use of the merged casting mold may help to eliminate oxide formation in a powder bed fusion process when aluminum is the selected casting material. Furthermore, the foam may be used as a gate frame to provide a platform or a substrate for casting the target part when being glued onto and or inserted into a 3D printed hollow shell.

An example of the merged casting mold is shown in FIGS. 1, 2, 12A, 12B, and 15. The 3D hollow shell of the full-sized target parts may be attached (e.g., glued) onto a separate gate frame, wherein the gate frame may be either partly hollow or solid, and the gate frame may be separately manufactured from a different polymer material, such as Styrofoam, polystyrene or polymethyl methacrylate (PMMA), or a co-polymer of PMMA and polystyrene. In one example, the gate frame of the different polymer material may be manufactured from foam blowing or machining.

In implementation, a merged casting mold may be formed by attaching the 3D printed hollow shell onto a separate gate frame manufactured from a different polymer material (e.g., Styrofoam). Depending upon the application and strength requirements, the gate frame may be manufactured as merely a partially hollow or entirely solid substrate for casting to increase the yield of multiple target parts. For example, the 3D printed hollow shell of the full-sized target parts may be glued down onto the separate gate frame to improve robustness and integrity of the pre-cast assembly for attaching to a separate conduit, which may be used for pouring of the molten selected cast material into the ceramic coated pre-cast assembly. The molten selected cast material may first burn off or evaporate the foam material in the gate frame (i.e., a bottom portion of the pre-cast assembly), then continue to burn off or evaporate the polymer materials (i.e., PLA) of the 3D printed hollow shell (i.e., a top portion of the pre-cast assembly).

After the evaporative casting using the merged casting mold, multiple target parts on the gate frame may be cut off, while the cast material of the gate frame may be salvaged or recycled for reuse in molten state.

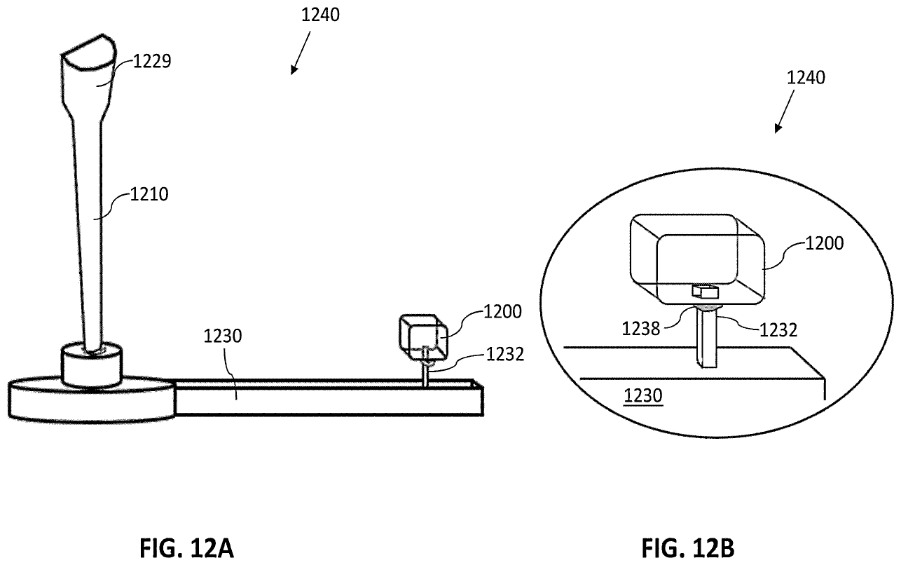

FIG. 12A illustrates a bottom gate pre-cast assembly 1240 that is connected via glue 1238 to an inlet of a conduit 1210 into which molten selected cast material may be poured. FIG. 12B illustrates a partial magnified view of bottom gate pre-cast assembly 1240. Conduit 1210, to include a downsprue 1229, a runner 1230, and an ingate 1232, provide a path (e.g., a tube, after coating with a ceramic mold) through which cast material is ducted into an interior of a ceramic mold formed around a hollow shell 1200. Assembly 1240 is an example of a merged casting mold, wherein a glue 1238 is used to secure a 3D printed hollow shell to ingate 1232, both of which are then coated with ceramic to form ceramic mold (where the ceramic mold is formed around hollow shell 1200).

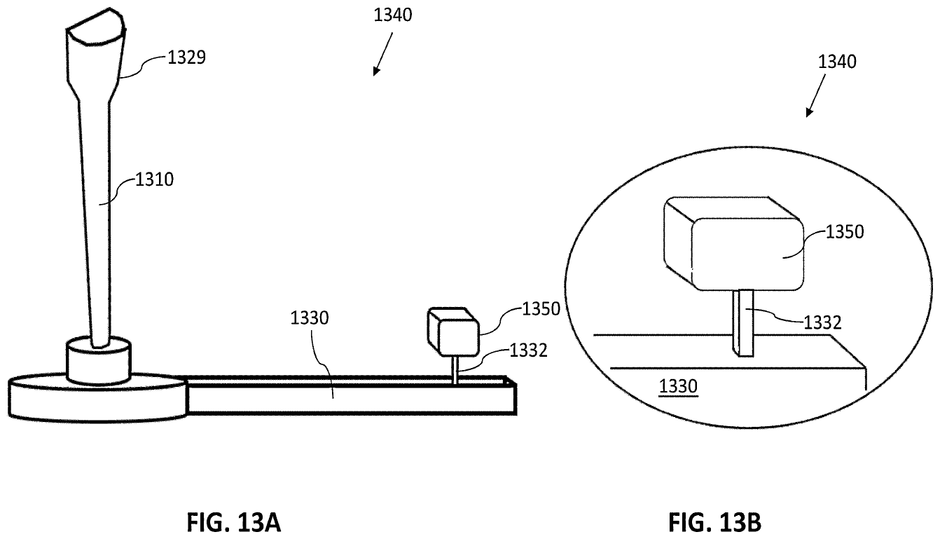

FIG. 13A illustrates a bottom gate pre-cast assembly 1340 that is connected to an inlet of a conduit 1310 into which molten selected cast material may be poured. FIG. 13B illustrates a partial magnified view of bottom gate pre-cast assembly 1340. Conduit 1310, to include a downsprue 1329, a runner 1330, and an ingate 1332, provide a path (e.g., a tube, after coating with a ceramic mold) through which cast material is ducted into an interior of a ceramic mold formed around a solid foam element 1350. Assembly 1340 is an example of a lost foam casting assembly, where a ceramic mold is formed around solid foam element 1350 rather than a 3D printed hollow shell. Solid foam element 1350 may be glued to ingate 1332, which may also be formed of a foam.

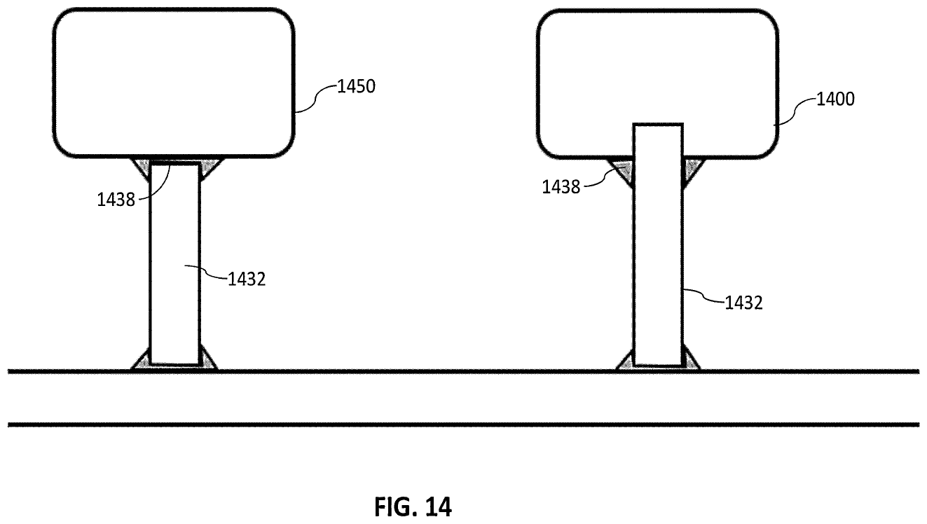

FIG. 14 illustrates a comparison of a lost foam pre-cast assembly (left) versus an additive manufacturing evaporative casting assembly (right). The lost foam assembly includes a solid foam element 1450, where the solid foam element is fixed via a glue 1438 at its surface to an end of an ingate 1432. The additive manufacturing evaporative casting assembly includes a 3D printed hollow shell 1400 with a beveled opening in hollow shell 1400 through which an ingate 1432 extends. A glue 1438 is applied between ingate 1432 and hollow shell 1400 around the bevel. In each arrangement, a ceramic material is applied to coat the outside of solid foam element 1450, hollow shell 1400 and the respective ingates 1432 to form a ceramic mold.

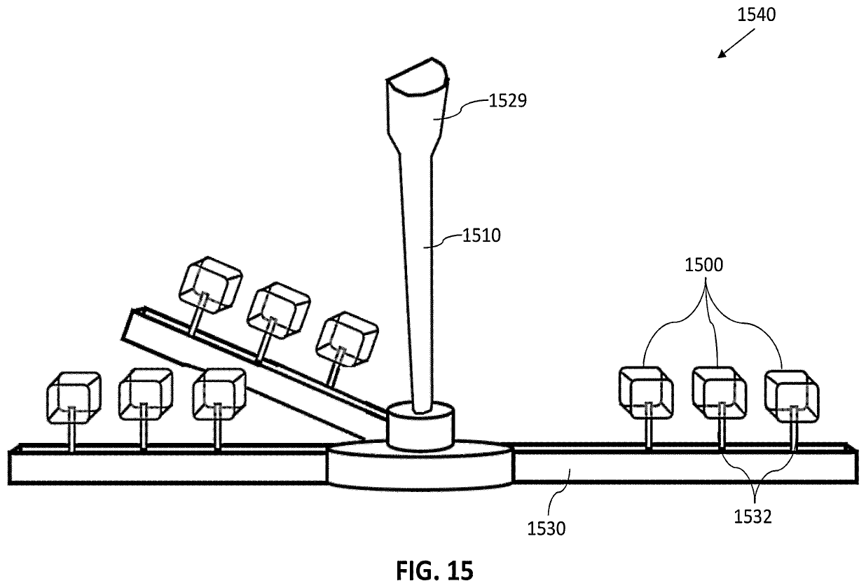

FIG. 15 illustrates a illustrates a bottom gate pre-cast cluster assembly 1540 that is connected to an inlet of a conduit 1510 into which molten selected cast material may be poured. Conduit 1510, to include a downsprue 1529, at least one runner 1530, and at least one ingate 1532, provide a path (e.g., a tube, after coating with a ceramic mold) through which cast material is ducted into an interior of a ceramic mold formed around a hollow shell 1500. Assembly 1540 is formed by connecting openings at the lower end of a hardened ceramic mold (formed around hollow shells 1500) to an end of conduit 1510 while an opposite end of conduit 1510 is configured as a cast material inlet to assembly 1540. In this manner, a plurality of cast parts may be cast simultaneously.

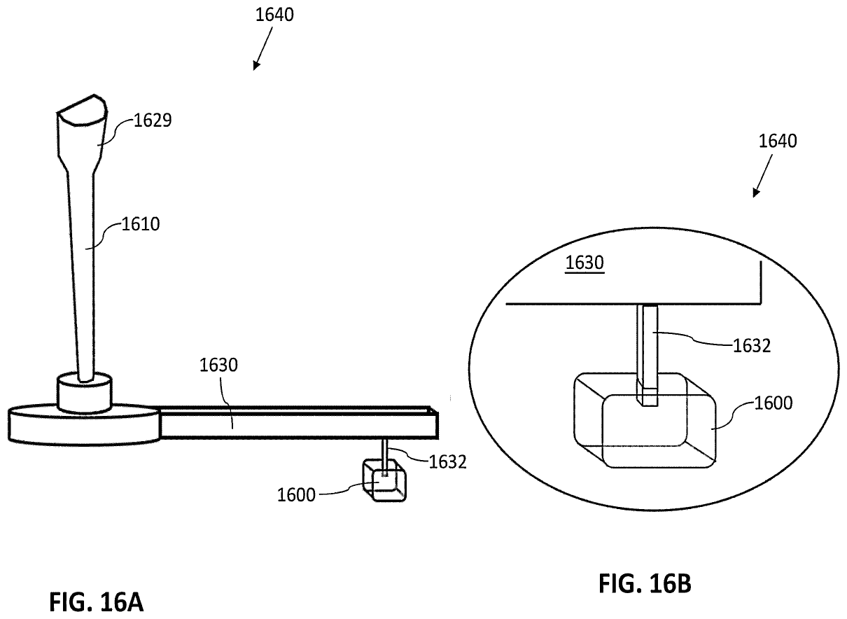

FIG. 16A illustrates a top gate pre-cast assembly 1640 that is connected to an inlet of a conduit 1610 into which molten selected cast material may be poured. FIG. 16B illustrates a partial magnified view of top gate pre-cast assembly 1640. Conduit 1610, to include a downsprue 1629, a runner 1630, and an ingate 1632, provide a path (e.g., a tube, after coating with a ceramic mold) through which cast material is ducted into an interior of a ceramic mold formed around a hollow shell 1600. Assembly 1640 is formed by connecting an opening at the lower end of a hardened ceramic mold (formed around hollow shell 1600) to an end of conduit 1610 while an opposite end of conduit 1610 is configured as a cast material inlet to assembly 1640.

As discussed above, a variety of factors lead to the successful casting of parts, without defects. The gating system (e.g., bottom gate versus top gate) is an important consideration to obtain a laminar flow of the cast material, and ensure that the pressure of the cast material within the ceramic mold is higher than the pressure of the vaporized polymer gas within the mold, so that the cast material pressure forces the vaporized polymer gas through the ceramic mold walls while the cast material remains hot enough to not solidify until casting is complete (e.g., the ceramic mold is filled and all uncast portions are eliminated). Additionally, using an olivine sand and/or ceramic beads to pack around the pre-cast assembly enables one to obtain precision tolerances and a desirable surface finish. Silica sand, on the other hand, may lead to undesirable surface finishes and poor tolerances (at least 10 times worse tolerances than those obtained using olivine sand and/or ceramic beads).

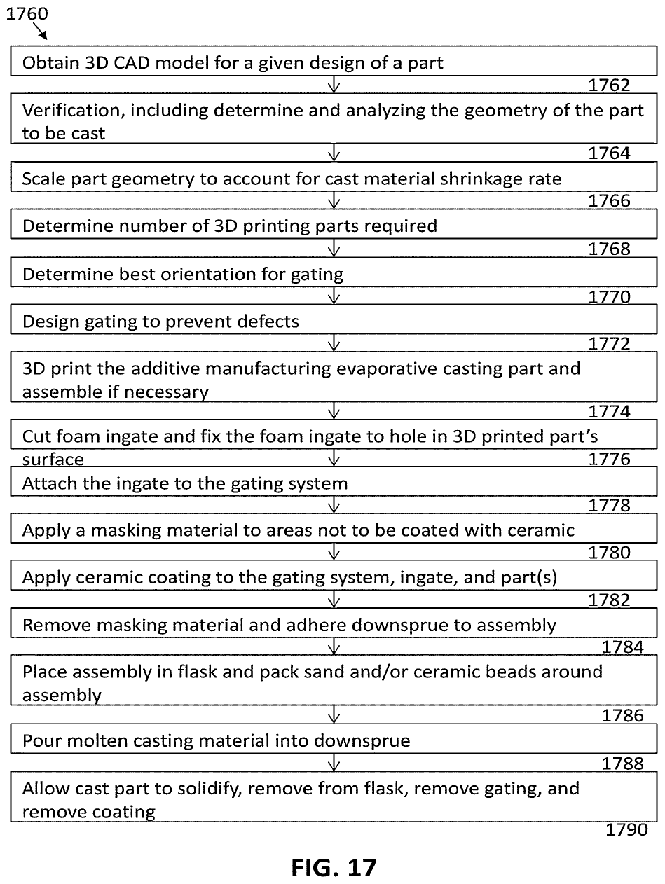

FIG. 17 illustrates an example method 1760 for obtaining a cast part. Method 1760 begins with obtaining a 3D computer-aided design (“CAD”) model for a given design of a part (step 1762).

Next, method 1760 includes a verification process, including determining and analyzing the geometry of the part to be cast (step 1764). The surface area of the part is determined and compared to the volume of the part. The ratio of the part surface area to the part volume should be greater than 3:1. If the ratio is less than 3:1, the casting material must be assessed to determine if the metal pour temperature can be increased without causing metallurgical defects or causing the metal to boil. If the ratio is less than 3:1, and if the metal pour temperature cannot be increased as noted, then the pre-cast assembly design is assessed to determine whether the metal static pressure can be increased. Finally, the location, orientation, and size of the ingate or ingates may be altered in a manner to provide cast material to problematic areas.

Next, method 1760 includes scaling the part geometry to account for the cast material shrinkage rate (step 1766). The shrinkage rate is considered from the cast material's solidus temperature to room temperature. The solidus temperature is the highest temperature at which a cast material, such as an alloy, is completely solid (before turning to a liquid). For complicated geometries, simply scaling may not be sufficient, and the part's geometry may require modification so that the final cast part has the proper dimensions.

Next, method 1760 includes determining the number of 3D printed parts required to obtain the total hollow shell (step 1768). Sometimes the hollow shell can be a single 3D printed part, and other times the hollow shell must be formed from multiple 3D printed parts assembled together. If the overhangs are more than about 38 mm (about 1.5 in.), then the 3D printing material (PLA) will likely sag. Thus, either supports must be added to the part, or the 3D printed part must be divided into multiple 3D printed parts. The CAD files to make the 3D printed parts are converted to STL command files, for directing the 3D printer. The volume of the print material is minimized by modifying the wall thickness and minimizing infill. The mass of the print material is determined.

Next, method 1760 includes determining the best orientation for gating (step 1770). This orientation focuses upon ensuring that the sand and/or ceramic beads are able to flow around the part once the pre-cast assembly is positioned within the flask. At least one hole is added to the 3D printed element's surface, either during the printing process (e.g., not printing in a certain area to create the hole) or afterward via machining or manual cutting of the hole. The hole(s) should be at least about 6.35 mm (0.25 in.) in diameter, but as large as the part allows for connection of the ingate(s).

Next, method 1760 includes designing the gating to prevent defects (step 1772). This process is described in detail above with reference to FIGS. 10A and 10B. In summary, gating must be designed to ensure that the pressure Pm is greater than the pressure Pg.

Next, method 1760 includes 3D printing the additive manufacturing evaporative casting part and assemble the parts where necessary (e.g., where multiple 3D printed elements were required to form the whole 3D printed part) (step 1774). Any support structure(s) and excess printing material is removed. Assembly of multiple 3D printed elements may include a compression fit, or fitting using an adhesive or polymer welding. Any adhesives used are kept at a minimum as the adhesives will produce gas when vaporized during casting.

Next, method 1760 includes cutting one or more foam ingate and fixing the foam ingate to the hole in the 3D printed part's surface (step 1776). The foam ingate should be slightly larger than the hole in the 3D printed part's surface, so that it can be inserted into the hole and remain in place via a compression fit (as illustrated in pre-cast assemblies 1140, 1540, and 1640). Alternatively, the ingate can be glued in place (as illustrated in pre-cast assembly 1240).

Next, method 1760 includes attaching the ingate to the gating system (step 1778).

Next, method 1760 includes applying a masking material, such as masking tape, to areas not to be coated with ceramic (step 1780). One example is the downsprue attachment point.

Next, method 1760 includes applying a ceramic coating to the gating system, ingate, and part(s) (step 1782). The coating should be mixed and diluted pursuant to the coating manufacturer's specifications or until the desired coating viscosity has been reached. Coating may be applied by dipping the gating system, ingate, and part(s) into the coating, pouring the coating over the assembly, or painting the coating onto the assembly. The gating system, ingate, and part(s) must be covered completely with coating. The parts and ceramic coating are left to dry. The ceramic coating must be completely dry to avoid a risk of steam explosions during casting. Any cracked or missed coating areas may receive touch-up coating.

Next, method 1760 includes removing masking materials and adhering a downsprue to the assembly (step 1784). The downsprue is the vertical funnel-like portion of the conduit. The downsprue may be a preformed ceramic item. The downsprue is adhered to the downsprue attachment point that was covered by a masking material during ceramic coating. The top (inlet) of the downsprue may be covered (e.g., with a paper cover) to prevent sand and/or ceramic beads from entering the top of the downsprue.

Next, method 1760 includes placing the assembly in a flask and packing sand and/or ceramic beads around the assembly (step 1786). An initial base of at least 50.8 mm (2.0 in.) of sand and/or ceramic beads is provided in the bottom of the flask before placement of the pre-cast assembly inside of the flask. The ceramic beads may be ID40 ceramic beads. Beads between AFS Grain Fineness Number (“AFN”) 20 and 80 may be used. Silica, olivine, or other types of natural or synthetic sands may be used. The sand and/or ceramic beads are vibrated into the flask around the pre-cast assembly until at least 254 mm (10 in.) of sand and/or ceramic beads cover the highest point of the ceramic mold, while the top of the downsprue extends above the level of the sand and/or ceramic beads.

Next, method 1760 includes pouring molten casting material into the top (inlet) of the downsprue (step 1788). Any covering of the top (inlet) of the downsprue (e.g., the paper cover) is removed, or perforated, prior to pouring. The casting material is heated to a temperature at least 65.6 degrees C. (150 degrees F.) above the casting material's melting point. The casting metal is poured into the downsprue as fast as possible, with a target rate of about 45.4 kg (100 lbs.) per second. The pouring should be continuous (without interruption) to avoid defects.

Next, method 1760 includes allowing the cast part to solidify, removing the assembly from the flask, removing gating, and removing the ceramic coating (step 1790). Solidification of the part typically takes at least one hour. The gating is removed by either knocking it off, or cutting it off. The ceramic coating may be removed by shotblasting, wire brush, rinsing, or the like.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments and aspects thereof, and while the embodiments and aspects have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A method for evaporative casting, comprising:
using three-dimensional (3D) printing to print only a hollow shell in 3D of at least one full-sized target part according to an algorithm;
applying a layer of ceramic coating over an entire exterior surface of the 3D printed hollow shell forming a hardened ceramic mold, wherein the hardened ceramic mold being fully enclosed and having an opening at a lower end;
forming a pre-cast assembly by connecting the opening at the lower end of the hardened ceramic mold to an end of a conduit, while an opposite end of the conduit is configured as an inlet to the pre-cast assembly;
burying completely the pre-cast assembly under compacted sand or ceramic beads wherein the inlet of the conduit is kept free and open at an upright position to receive a selected cast material in a molten state;
pouring the selected cast material in molten state into the inlet of the pre-cast assembly, wherein the selected cast material in a molten state travels down the conduit by gravity to entirely fill the pre-cast assembly by evaporating all of the 3D printed hollow shell, such that the selected cast material in a molten state completely fills up an entire volume enclosed by an inner surface of the hardened ceramic mold; and
cooling to solidify the selected cast material inside the pre-cast assembly to yield a cast of the at least one full-sized target part.

2. The method of claim 1, wherein polymer materials including polylactic acid (PLA) based filaments are used in printing the 3D printed hollow shell.

3. The method of claim 1, wherein the 3D printed hollow shell comprises polymer materials having a wall thickness between 0.15 mm and 1.00 mm.

4. The method of claim 1, comprising attaching the 3D printed hollow shell of the at least one target part onto a separate gate frame, wherein the gate frame is either partly hollow or solid and is separately manufactured from a foam material.

5. The method of claim 4, wherein the attaching of the 3D printed hollow shell of the at least one target part onto the separately manufactured gate frame comprises adhering the 3D printed hollow shell to the gate frame with a glue.

6. The method of claim 4, wherein the attaching of the 3D printed hollow shell of the at least one target part onto the separately manufactured gate frame comprises compression fitting a hole in the 3D printed hollow shell to the gate frame.

7. The method of claim 5 or 6, wherein a foam ingate is fixed between the 3D printed hollow shell and the gate frame.

8. The method of claim 7, wherein the foam ingate is adhered to the gate frame at a first end, and fixed to the 3D printed hollow shell at a second end.

9. The method of claim 4, wherein the gate frame of the foam material is manufactured from foam blowing or machining.

10. The method of claim 1, wherein the hardened ceramic mold has a wall thickness between 0.025 mm and 0.381 mm.

11. The method of claim 1, wherein the selected cast material comprises: aluminum alloys, brass alloys, copper alloys, bronze alloys, iron alloys, steel alloys, stainless steel, nickel, nickel alloys, or a combination thereof.

12. The method of claim 1, wherein the pre-cast assembly is buried in positions comprising one of: upright, inverted, and tilted at an angle.

13. The method of claim 12, wherein an inverted, a tilted angle, or an upright buried position is dependent upon a density of the selected cast material used.

14. The method of claim 1, wherein the pre-cast assembly is arranged in a bottom gate configuration.

15. The method of claim 1, wherein the pre-cast assembly is arranged in a top gate configuration.

16. The method of claim 1, wherein the evaporated 3D printed hollow shell creates a gas within the hardened ceramic mold, the gas having a gas pressure, wherein the molten cast material includes a metal static pressure, and wherein the metal static pressure is greater than the gas pressure.

17. The method of claim 16, wherein the gas within the hardened ceramic mold escapes from the hardened ceramic mold through a wall of the hardened ceramic mold.

18. The method of claim 16, wherein the molten cast material evaporates the 3D printed hollow shell as the molten cast material comes close to the 3D printed hollow shell, creating a temporary shell-free area between the molten cast material and the 3D printed hollow shell.

19. The method of claim 18, wherein the gas within the hardened ceramic mold escapes from the hardened ceramic mold through a wall of the hardened ceramic mold in the shell-free area.

20. The method of claim 16, wherein perforations are manually formed through the 3D printed hollow shell.
